(19) United States
(12) Patent Application Publication
(10) Pub. No.: US 2016/0178480 A1
(43) Pub. Date: Jun. 23, 2016

(54) CRANKSHAFT POSITION SENSING SYSTEM

(71) Applicant: Ford Global Technologies, LLC, Dearborn, MI (US)

(72) Inventors: Paul Nigel Turner, Chelmsford (GB); Jack Slater, Wickford (GB); Glen McMillan, Benfleet (GB); Jack Herbert, Chelmsford (GB)

(21) Appl. No.: 14/941,153

(22) Filed: Nov. 13, 2015

(30) Foreign Application Priority Data
Dec. 18, 2014 (GB) 1422572.6

(51) Int. Cl. G01M 15/06; F02B 77/08

(52) U.S. Cl. CPC G01M 15/06; F02B 77/085

(57) ABSTRACT

A crankshaft position sensing system for an engine, the crankshaft position sensing system comprising: a trigger wheel, and a position sensor configured to detect the angular position of the trigger wheel, the position sensor being further configured to extend through an opening in a wall of a casing of the engine, wherein the position sensor has a body portion and a sensor portion, the sensor portion being provided at a distal end of the body portion, the body portion distal end being adjacent to the trigger wheel in an installed configuration, wherein the body portion has a longitudinal axis that is inclined to a radial plane of the trigger wheel when in the installed configuration.

### CROSS REFERENCE TO RELATED APPLICATION

The present application claims priority to Great Britain Patent Application No. 1422572.6, filed Dec. 18, 2014, the entire contents of which are hereby incorporated by reference for all purposes.

### FIELD

This disclosure relates to a crankshaft position sensing system and in particular, but not exclusively, relates to a crankshaft position sensing system comprising a crankshaft trigger wheel and a position sensor.

### BACKGROUND AND SUMMARY

The position and the rotational speed of the crankshaft of an internal combustion engine are typically monitored. The information about the position and the rotational speed of the crankshaft may be used to control operational parameters of the engine and/or the operation of components, such as fuel injectors and/or spark plugs.

The position and/or the rotational speed of the crankshaft can be monitored using a trigger wheel, which is coupled to a rotating component of the engine, and a position sensor configured to detect the rotational position of the trigger wheel. Typically, the trigger wheel is mounted externally to the engine, for example to a crankshaft pulley or to a flywheel. The position sensor is usually mounted perpendicular to the teeth of the trigger wheel in order to ensure reliable measurement of the position and/or the rotational speed of the crankshaft. Such a requirement places a limitation on where the trigger wheel and the position sensor may be packaged in respect to the engine.

In order to reduce the overall length of the engine when installed into a vehicle, it may be desirable to mount the trigger wheel internally to the engine. This places a further restriction on where the position sensor may be packaged.

According to an aspect of the present invention there is provided a crankshaft position sensing system for an engine, for example an internal combustion engine for a motor vehicle. The crankshaft position sensing system comprises a trigger wheel. The crankshaft position sensing system comprises a position sensor configured to detect the angular position of the trigger wheel. The position sensor is configured to extend through an opening in a wall of a casing of the engine. The position sensor has a body portion and a sensor portion. The sensor portion is provided at a distal end of the body portion. The body portion distal end is adjacent to the trigger wheel in an installed configuration. The position sensor has a longitudinal axis that is inclined to a radial plane of the trigger wheel when in an installed configuration, for example, when the trigger wheel is coupled to a crankshaft of the engine and the position sensor is secured to the casing of the engine. In one example, the longitudinal axis of the position sensor may be referred to as a first longitudinal axis.

The trigger wheel may comprise a plurality of projections, for example teeth, extending axially and/or radially from the trigger wheel. The trigger wheel may comprise a plurality of trigger wheel surfaces configured to be detected by the position sensor. The trigger wheel surfaces may be at least partially planar, for example the trigger wheel surfaces may be at least partially flat. The trigger wheel surfaces may be at least partially curved. The trigger wheel surfaces may be inclined with respect to the radial plane of the trigger wheel.

The projections on the trigger wheel may each comprise one or more trigger wheel surfaces. The trigger wheel surfaces and the sensor surface may be configured to face each other. The trigger wheel surfaces and the sensor surface may be substantially parallel. The projections may be uniform in cross section along the length of the projection, for example the projections may be substantially square in cross section. The projections may have a non-uniform cross section along the length of the projection, for example the projections may be generally wedge-shaped.

The sensor portion may comprise a sensor surface inclined relative to the longitudinal axis of the position sensor. The body portion may be orientated about the longitudinal axis. The body portion may be elongate. The sensor portion may be orientated at an angle relative to the body portion. The sensor portion may extend at an angle from the body portion in a direction away from the longitudinal axis of the position sensor. The body portion and the sensor portion may be integrally formed. The sensor portion may be coupled, for example movably coupled, to the body portion.

The position sensor may be configured to be coupled, for example removably secured, to the engine casing, for example a cylinder block. The position sensor may be a Hall effect type sensor. The position sensor may be an optical type sensor. The position sensor may be located towards the intake side of the engine.

An engine may comprise the crankshaft position sensing system.

The trigger wheel may be coupled to a crankshaft of the engine. The trigger wheel may be provided in between a crankshaft counterweight and a wall of an engine casing. The trigger wheel may be provided adjacent to a crankshaft bearing. The trigger wheel may be coupled to an end of the crankshaft closest to a fly wheel of the engine. The trigger wheel may be inside the engine casing. The opening in the wall of the engine casing may be spaced apart from the trigger wheel in a direction defined by the crankshaft longitudinal axis.

A vehicle may comprise a crankshaft positioning system or an engine according to the present disclosure.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 is a partial cross section through an example of an engine showing a trigger wheel, a position sensor, an engine block and a crankshaft;

FIG. 2 is a perspective view showing the trigger wheel of FIG. 1;

FIG. 3 is a partial cross section through another example of an engine showing a trigger wheel, a position sensor, an engine block and a crankshaft;

FIG. 4 is a perspective view showing the trigger wheel of FIG. 3;

FIG. 5 is a partial cross section through a further example of an engine showing a trigger wheel, a position sensor, a cylinder block and a crankshaft;

FIG. 6 is a perspective view showing the trigger wheel of FIG. 5; and

FIG. 7 is a perspective view of the trigger wheel and the position sensor of FIG. 5.

### DETAILED DESCRIPTION

FIG. 1 shows a crankshaft position sensing system 101 for an engine 128 of a motor vehicle according to a first example of the present disclosure. The crankshaft position sensing system 101 comprises a trigger wheel 103 and a position sensor 105. In the example of FIG. 1, the trigger wheel 103 is provided inside an engine casing, for example a cylinder block of the engine, and is coupled to a crankshaft 107 of the engine. The trigger wheel 103 is disposed in between a counterweight 109 of the crankshaft 107 and a wall 111 of the engine casing. The crankshaft 107 may be supported by a bearing provided in the wall 111 of the engine casing.

The trigger wheel 103 is disposed towards an end of the crankshaft 107 closest to a fly wheel of the engine (not shown). In this manner, the trigger wheel 103 is closely coupled to the inertia of the flywheel, which reduces the torsional acceleration of the trigger wheel 103. The trigger wheel 103 may however be installed at any appropriate location on the engine, for example the trigger wheel 103 may be located externally to the engine and may be coupled to a crankshaft pulley or the flywheel.

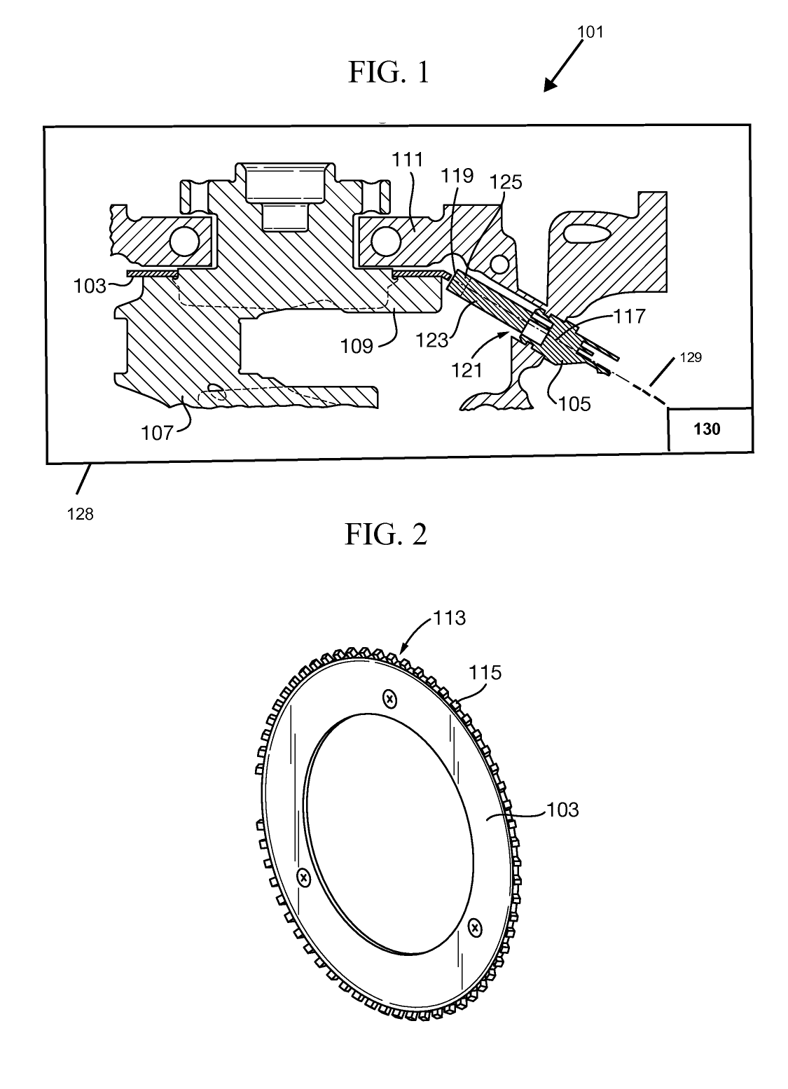

The trigger wheel 103 comprises a plurality of projections, for example teeth 113, located around the periphery of the trigger wheel 103. In FIG. 2, the teeth 113 extend from the outer circumference of the trigger wheel 103 in an axial direction and a radial direction, i.e. the teeth 113 extend away from the axis of rotation of the trigger wheel 103 in a direction that is not parallel to the radial plane of the trigger wheel. In an alternative example, the teeth 113 may extend axially and/or radially away from an axial end face of the trigger wheel 103. In FIGS. 1 and 2, the teeth 113 extend in a direction away from the wall 111 of the engine casing. However, in an alternative example, the teeth 113 may extend in a direction towards the wall 111 of the engine casing. In the example shown in FIGS. 1 and 2, the teeth 113 may be pressed into a desired form during the pressing of the trigger wheel 103.

The trigger wheel 103 comprises a plurality of trigger wheel surfaces 115 configured to be detected by the position sensor 105. In FIGS. 1 and 2, each of the teeth 113 comprises a trigger wheel surface 115, the trigger wheel surface 115 forming a terminating end surface of each tooth 113. In FIGS. 1 and 2, the trigger wheel surfaces 115 are curved surfaces having a constant radius about the axis of rotation of the trigger wheel 103. In an alternative example, the trigger wheel surfaces 115 may be flat planar surfaces that are angled with respect to the radial plane of the trigger wheel 103. Such planar trigger wheel surfaces 115 may be normal to the direction in which the teeth 113 extend away from the radial plane of the trigger wheel 103. The trigger wheel surfaces 115 may however be of any appropriate form that permit the trigger wheel surfaces 115 to be detected by the position sensor 105. Additionally or alternatively, the trigger wheel surfaces 115 may be at least partially recessed into the body of the trigger wheel 103.

In FIG. 1, the position sensor 105 is fixed to the engine casing and extends though an opening 121 in the wall 111 of the engine casing. The position sensor 105 may be a Hall effect type sensor, although alternative types of sensors that are configured to detect the angular position of the trigger wheel, for example optical sensors, may be used. The position sensor 105 has a body portion 123 and a sensor portion 125. The sensor portion 125 is provided at a distal end of the body portion 123. The distal end of the body portion 123 end is adjacent to the trigger wheel 105 in an installed configuration. The position sensor 105 has a longitudinal axis 117 that is inclined to a radial plane of the trigger wheel 103 when in an installed configuration, for example, when the trigger wheel 103 is coupled to the crankshaft 107 of the engine and the position sensor 105 is secured to the wall 111 of the engine casing.

In the example of FIG. 1, the longitudinal axis 117 of the position sensor 105 is inclined at about 30° to the radial plane of the trigger wheel 103. In alternative examples, however, the longitudinal axis 117 of the position sensor 105 may be inclined at any appropriate angle. The inclination of the position sensor 105 in this way allows the opening 121 in the engine casing wall 111 to be spaced apart from the axial location of the trigger wheel 103. This in turn permits the trigger wheel 103 to be closer to the flywheel as there is a limited package space around the engine casing in the vicinity of the flywheel. Advantageously, the arrangement of the position sensor 105 described above reduces the package size of the engine.

The sensor portion 125 comprises a sensor surface 119 that is configured to face the trigger wheel surfaces 115 as the trigger wheel 103 rotates. In FIG. 1, the sensor surface 119 is normal to the longitudinal axis 117 of the position sensor 105, with the longitudinal axis 117 inclined to the radial plane of the trigger wheel 103. In this manner, the sensor surface 119 may be placed at a non-perpendicular angle relative to the radial direction of the trigger wheel 103.

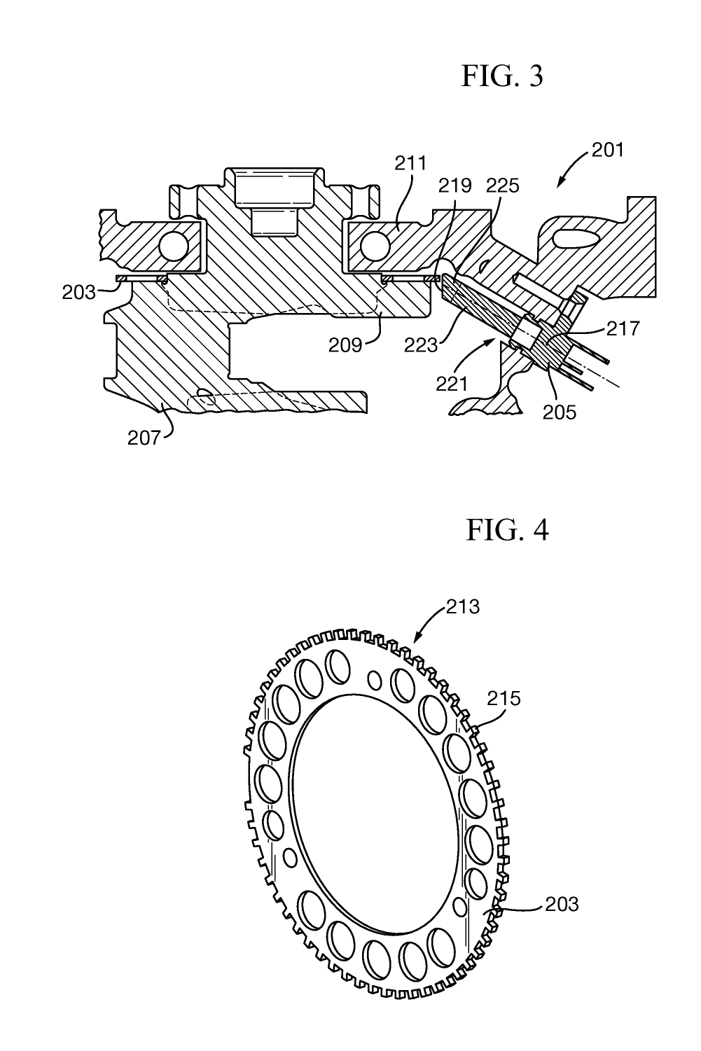

FIGS. 3 and 4 show a second example of the crankshaft position sensing system 201 according to the present disclosure. To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

As depicted in FIGS. 3 and 4, the trigger wheel 203 comprises a plurality of teeth 213 that extend radially from the trigger wheel 203, for example without extending in the axial direction. Each of the teeth 213 comprise a terminating end surface forming one of the trigger wheel surfaces 215 configured to be detected by the position sensor 205. The position sensor 205 has a longitudinal axis 217 that is inclined to a radial plane of the trigger wheel 203. The position sensor 205 has a sensor surface 219 that is inclined relative to the longitudinal axis 217 of the position sensor 205. In FIG. 3, the sensor surface 219 is a flat planar surface. However, sensor surface 219 may be of any appropriate form to permit the position sensor 205 to reliably detect the trigger wheel surfaces 215, for example the sensor surface 219 may be at least partially curved.

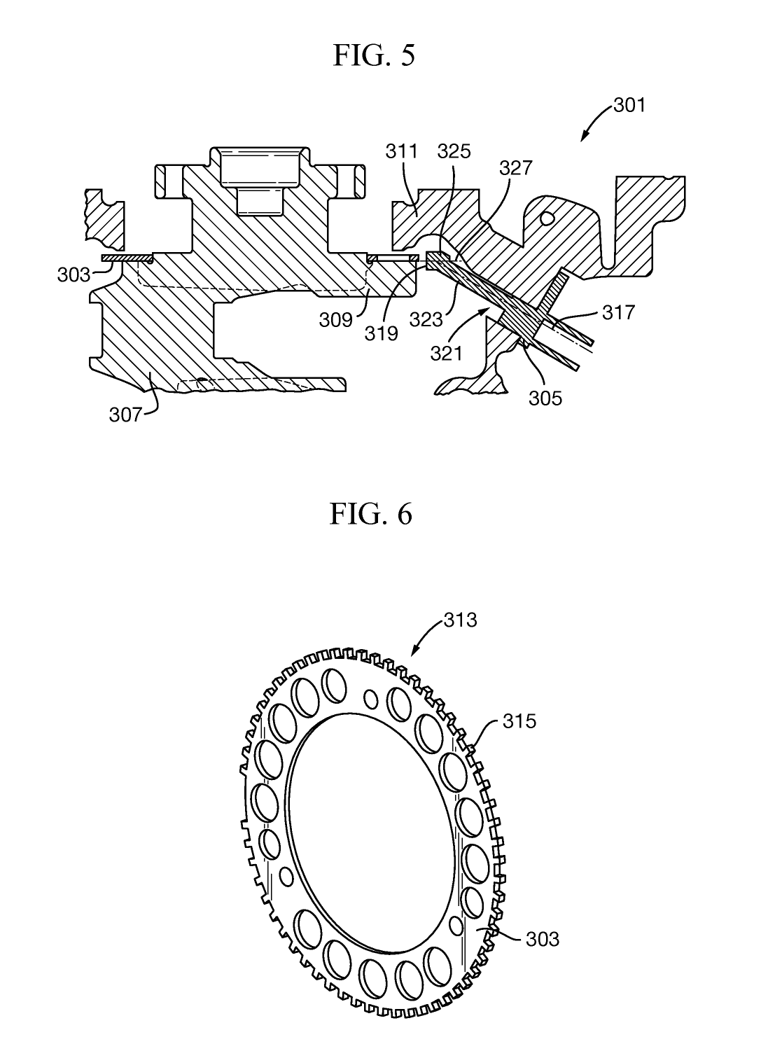

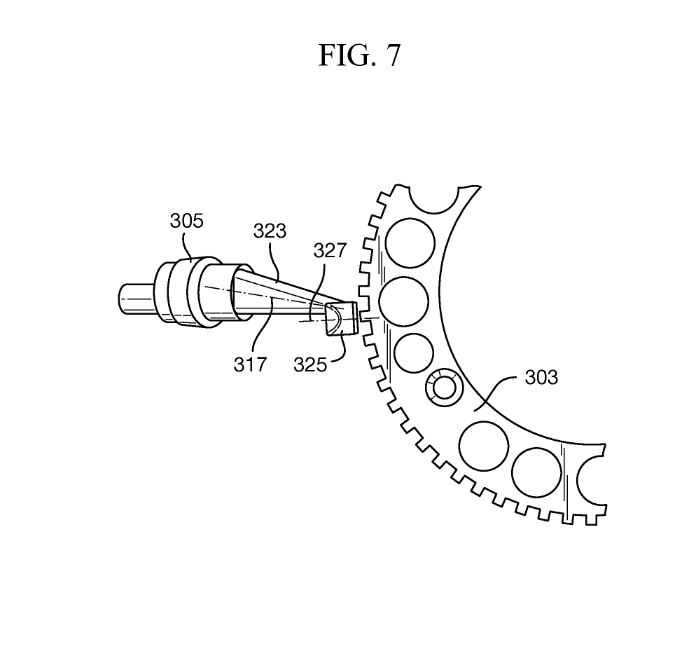

In FIGS. 5 to 7, the trigger wheel 303 is similar to the trigger wheel 203 of the example shown in FIGS. 3 and 4. Each of the teeth 313 comprise a terminating end surface forming one of the trigger wheel surfaces 315 configured to be detected by the position sensor 305. The position sensor 305 has a longitudinal axis 317 that is inclined to a radial plane of the trigger wheel 303. In the example shown in FIGS. 5 and 7, the position sensor comprises a body portion 323 orientated about the longitudinal axis 317. The position sensor 303 comprises sensor portion 325 disposed towards the distal end of the body portion 323 that is closest to the trigger wheel 303. The sensor portion 325 is angled with respect to the body portion 323. In the example of FIGS. 5 and 7, the sensor portion 325 has a second longitudinal axis 327 that is orientated in the radial plane of the trigger wheel 303. In an alternative example, however, the second longitudinal axis 327 may be orientated at any appropriate angle, for example the second longitudinal axis 327 may be angled with respect to the longitudinal axis 317 of the position sensor 305 and/or the radial plane of the trigger wheel 303.

In the examples shown in FIGS. 1 to 7, the trigger wheel 103, 203, 303 of the crankshaft position sensing system 101, 201, 301 is coupled directly to the crankshaft. However, in alternative examples of the present invention, the trigger wheel 103, 203, 303 may be coupled to any appropriate rotating component of the engine, for example a camshaft of the engine, and/or ancillary device of the engine, for example an oil pump.

The crankshaft position sensing system 101, 201, 301 may further comprise a controller 130, including non-transitory memory, configured to receive a signal 129 from the position sensor 105, 205, 305. The controller 130 is depicted in FIG. 1, as well as engine 128 and signal 129. Though not labelled in FIGS. 3 and 5, it is understood that the crankshaft position sensing systems 201 and 301 similarly comprise a controller, engine and signal.

The controller may be configured to determine the rotational speed of the crankshaft 107, 207, 307 based upon the rate of change of position of the trigger wheel 103, 203, 303. The controller may be configured to output a control signal to control one or more operational parameters of the engine according to the determined speed of the crankshaft 107, 207, 307.

It will be appreciated by those skilled in the art that although the invention has been described by way of example with reference to one or more examples, it is not limited to the disclosed examples and that alternative examples could be constructed without departing from the scope of the invention as defined by the appended claims.

1. A crankshaft position sensing system for an engine, the crankshaft position sensing system comprising:
a trigger wheel; and
a position sensor configured to detect the angular position of the trigger wheel, the position sensor being further configured to extend through an opening in a wall of a casing of the engine,
wherein the position sensor has a body portion and a sensor portion, the sensor portion being provided at a distal end of the body portion, the body portion distal end being adjacent to the trigger wheel in an installed configuration, wherein the body portion has a longitudinal axis that is inclined to a radial plane of the trigger wheel when in the installed configuration.

2. The crankshaft position sensing system according to claim 1, wherein the trigger wheel comprises a plurality of projections extending axially and/or radially from the trigger wheel.

3. The crankshaft position sensing system according to claim 1, wherein the trigger wheel comprises a plurality of trigger wheel surfaces configured to be detected by the position sensor, wherein the trigger wheel surfaces are inclined with respect to the radial plane of the trigger wheel.

4. The crankshaft position sensing system according to claim 2, wherein the projections each comprise a trigger wheel surface.

5. The crankshaft position sensing system according to claim 1, wherein the sensor portion comprises a sensor surface inclined relative to the longitudinal axis of the position sensor.

6. The crankshaft position sensing system according to claim 1, wherein the body portion is elongate.

7. An engine comprising a crankshaft position sensing system, the crankshaft position sensing system comprising:
a trigger wheel; and
a position sensor configured to detect the angular position of the trigger wheel, the position sensor being further configured to extend through an opening in a wall of an engine casing of the engine,
wherein the position sensor has a body portion and a sensor portion, the sensor portion being provided at a distal end of the body portion, the body portion distal end being adjacent to the trigger wheel in an installed configuration, wherein the body portion has a longitudinal axis that is inclined to a radial plane of the trigger wheel when in the installed configuration.

8. The engine according to claim 7, wherein the trigger wheel is coupled to a crankshaft of the engine.

9. The engine according to claim 8, wherein the trigger wheel is coupled to an end of the crankshaft closest to a fly wheel of the engine.

10. The engine according to claim 7, wherein the trigger wheel is provided in between a crankshaft counterweight and the wall of the engine casing.

11. The engine according to claim 7, wherein the trigger wheel is provided adjacent to a crankshaft bearing.

12. The engine according to claim 7, wherein the opening in the wall of the engine casing is spaced apart from the trigger wheel in a direction defined by the longitudinal axis of a crankshaft in an installed configuration.

13. The engine according to claim 7, wherein the trigger wheel is inside the engine casing.

14. A crankshaft position sensing system for an engine, the crankshaft position sensing system comprising:
a trigger wheel; and
a position sensor configured to detect the angular position of the trigger wheel, the position sensor being further configured to extend through an opening in a wall of a casing of the engine,
wherein the position sensor has a body portion and a sensor portion, the sensor portion being provided at a distal end of the body portion, the body portion distal end being adjacent to the trigger wheel in an installed configuration, wherein the body portion has a longitudinal axis that is inclined to a radial plane of the trigger wheel when in the installed configuration,
wherein the trigger wheel comprises a plurality of trigger wheel surfaces configured to be detected by the position sensor, wherein the trigger wheel surfaces are inclined with respect to the radial plane of the trigger wheel,
wherein the sensor portion comprises a sensor surface inclined relative to the longitudinal axis of the position sensor.

15. The crankshaft position sensing of claim 1, wherein the position sensor comprises a body portion oriented about the longitudinal axis, wherein the position sensor is angled with respect to the body portion.

16. The crankshaft position sensing of claim 1, wherein the position sensor has a second longitudinal axis that is oriented in the radial plane of the trigger wheel.

17. The crankshaft position sensing system of claim 16, wherein the second longitudinal axis is angled with respect to the longitudinal axis of the position sensor and/or the radial plane of the trigger wheel.

18. The crankshaft position sensing system of claim 5, wherein the sensor surface is disposed at a non-perpendicular angle relative to the radial plane of the trigger wheel.

19. The crankshaft position sensing system of claim 1, further comprising a controller configured to receive a signal from the position sensor, wherein the controller is configured to determine the rotational speed of the crankshaft.

20. The crankshaft position sensing system of claim 1, wherein the sensor surface is at least partially curved.
